(19) United States
(12) Patent Application Publication
(10) Pub. No.: US 2025/0392678 A1
(43) Pub. Date: Dec. 25, 2025

(54) STORAGE MEDIUM, INFORMATION PROCESSING DEVICE, AND INFORMATION PROCESSING DEVICE CONTROL METHOD

(71) Applicant: CANON KABUSHIKI KAISHA, Tokyo (JP)

(72) Inventors: HIDEKAZU NAKASHIO, Saitama (JP); YUKIHIRO SHINDO, Chiba (JP)

(21) Appl. No.: 19/233,424

(22) Filed: Jun. 10, 2025

(30) Foreign Application Priority Data
Jun. 21, 2024 (JP) 2024-100706

(51) Int. Cl. H04N 1/60; G01J 3/52

(52) U.S. Cl. CPC H04N 1/6033; G01J 3/52

(57) ABSTRACT

An information processing device control method for performing color measurement on a color patch arranged on a chart printed out from an image forming apparatus to verify color accuracy of the image forming apparatus is provided, which accepts a color verification specification regarding color accuracy verification, determines whether or not a tolerance value set in the accepted color verification specification is within an acceptable range, and registers the color verification specification if the set tolerance value is determined to be within the acceptable range.

### BACKGROUND

### Technical Field

The present disclosure relates to a storage medium, an information processing device, and an information processing device control method.

### Description of the Related Art

In general, commercial color printers regularly undergo color management to ensure constant color reproduction. Color management is performed by comparing a target color, as defined by standards such as ISO, with the color actually printed by the printer and verifying that the color accuracy meets the acceptance criteria (tolerance values). If the color accuracy does not meet the tolerance values, in order to improve the color accuracy, it is necessary to recreate print profiles or to perform correction processing using the color correction function of the printer, but these tasks require significant time and effort, and thus, it is desirable to perform these tasks efficiently. Japanese Patent Laid-Open No. 2021-196723 proposes a technology that, after verifying whether the color accuracy of a printer meets the tolerance values (color verification), compares the target color gamut with the printer color gamut on the basis of the color measurement history and determines whether or not even the changed target color is likely to meet the color verification acceptance criteria.

However, the above-mentioned existing technology has the problem described below. For example, when the user customizes the tolerance values for color verification and performs color verification, if the tolerance values are too strict and exceed printer performance, color verification failures (color verification NGs) will occur frequently and color management cannot perform correctly.

### SUMMARY

An information processing device according to the present disclosure is configured to perform color measurement on a color patch arranged on a chart printed out from an image forming apparatus to verify color accuracy of the image forming apparatus, the information processing device comprising: at least one memory storing a program; and at least one processor that is configured to operate, by executing the stored program, as: an acceptance unit configured to accept a color verification specification regarding color accuracy verification, and a determination unit configured to determine whether or not a tolerance value set in the accepted color verification specification is within an acceptable range and register the color verification specification if the set tolerance value is determined to be within the acceptable range.

Further features of the present disclosure will become apparent from the following description of exemplary embodiments with reference to the attached drawings.

### BRIEF DESCRIPTION OF THE DRAWINGS

FIG. 1 is a diagram illustrating an example of the configuration of a color verification system.

FIGS. 2A to 2C are diagrams illustrating an example of patch signal values and color properties for a color verification chart.

FIG. 3 is a diagram illustrating an example of the hardware configuration of a color verification device and control device.

FIG. 4 is a diagram illustrating an example of a main functional configuration of the color verification device.

FIG. 5 is a sequence diagram illustrating an example of the process flow in the color verification system.

FIGS. 6A to 6L are diagrams illustrating examples of display screens.

FIGS. 7A to 7C are diagrams illustrating an example of an error notification screen and examples of a tolerance value input screen.

FIG. 8 is a diagram illustrating an example of the processes in S503 and S504 of FIG. 5 in a first embodiment.

FIG. 9 is a diagram illustrating another example of the processes in S503 and S504 of FIG. 5 in the first embodiment.

FIG. 10 is a diagram illustrating an example of the configuration of a profile.

FIG. 11 is a diagram illustrating an example of color matching processing.

FIG. 12 is a diagram illustrating an example of the processes in S503 and S504 of FIG. 5 in a second embodiment.

FIGS. 13A and 13B are diagrams illustrating an example of upper density limits and lower density limits for signal values.

### DESCRIPTION OF THE EMBODIMENTS

In the following, embodiments of the present disclosure will be described on the basis of the drawings. The following embodiments do not intend to limit the scope of the claims to what has been expressly disclosed. Multiple features are described in the embodiments; however, not all of these multiple features may be essential, and the multiple features may be combined freely. Furthermore, to the extent the same or substantially the same configurations are assigned identical reference numbers in the accompanying drawings, redundant descriptions will be omitted.

### First Embodiment

In a first embodiment, an example will be described in which it is checked in advance whether or not test contents (tolerance values) to be set are valid at the time of registration of a color verification specification (a color verification test specification) in a case where color verification is performed using one or more tolerance values customized by a user. In the example of the present embodiment, one or more thresholds are calculated through simulation using one or more profiles to simulate color conversion errors in software, and the validity of the calculated thresholds is determined on the basis of whether or not the one or more calculated thresholds (or, alternatively, predetermined thresholds) meet the one or more tolerance values. This prevents the registration of a color verification specification in which inappropriate one or more tolerance values are set. An example will be described in which the occurrence of failed color verification (color verification NGs) due to the setting of one or more inappropriate tolerance values is prevented.

### System Configuration

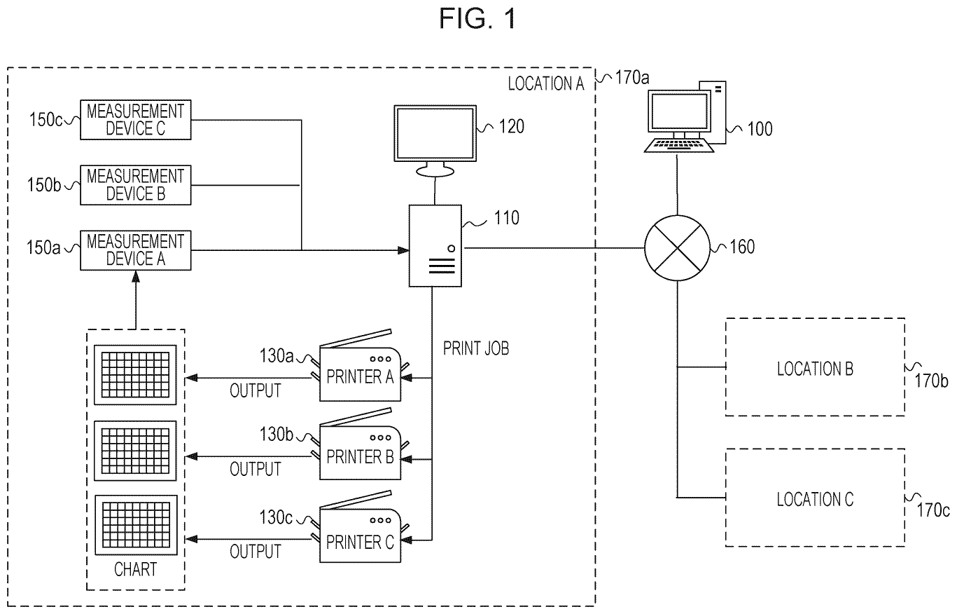

An example of the configuration of a color verification system according to the present embodiment will be described with reference to FIG. 1. FIG. 1 is a diagram illustrating an example of the configuration of the color verification system according to the present embodiment. When color accuracy is verified in the color verification system according to the present embodiment, first, a predetermined chart is printed out from a verification target printer. Next, a color patch on the printed-out chart is measured by a measurement device, and the obtained color measurement data is transmitted to a color verification device 100. The color verification device 100 then checks the deviation (color accuracy) between the printed color and a target color. The color patches arranged on the chart are also called color swatches, or color samples, and are referred to simply as “patches” in this specification.

As illustrated in FIG. 1, in the color verification system, the color verification device 100 and locations A to C (170a to 170c) are connected by a network 160. The location A 170a includes a control device 110, a monitor 120, printers A to C (130a to 130c), and measurement devices A to C (150a to 150c). Each of the locations B 170b and C 170c also includes a control device, a monitor, printers, and measurement devices. In the following, the relationship between the location A 170a and the color verification device 100 will be described as an example.

The color verification device 100 compares a predefined target color (target color) with the color actually printed by the printer (printed color) to verify whether the color accuracy meets an acceptance criterion. The color verification device 100 is connected to the control device 110 via the network 160 such that two-way communication is possible.

The control device 110 is connected to the printers 130a to 130c in the location A 170a via a communication network, such as an intranet, such that two-way communication is possible. The control device 110 issues a print command to each printer and also performs centralized management of the color accuracy of each printer, for example. It is possible, for example, to receive a print job from a client terminal (not illustrated), divide the print job into predetermined units (for example, copy units or page units), and then issue print commands to multiple printers in a distributed manner. The print job includes a Page Description Language (PDL) data section that describes the drawing commands for each attribute object, such as text, graphics, and photographs, on a page-by-page basis, and printing setting information that specifies the paper size and type, double-sided/single-sided printing, and other printing conditions. By issuing print commands such that a single print job is distributed to multiple printers, the printing time and the print waiting time can be shortened. The monitor 120 is connected to the control device 110 and displays various user interface screens (UI screens).

The printers A to C (130a to 130c) print color images on paper sheets based on the print jobs received from the control device 110, for example, using electrophotographic process technology. The printers A to C (130a to 130c) are examples of image forming apparatuses. The printers A to C (130a to 130c) may be monochrome printers or printers based on other image forming technologies such as inkjet. The printers A to C (130a to 130c) may also be multifunction machines having copy and FAX functions in addition to the print function.

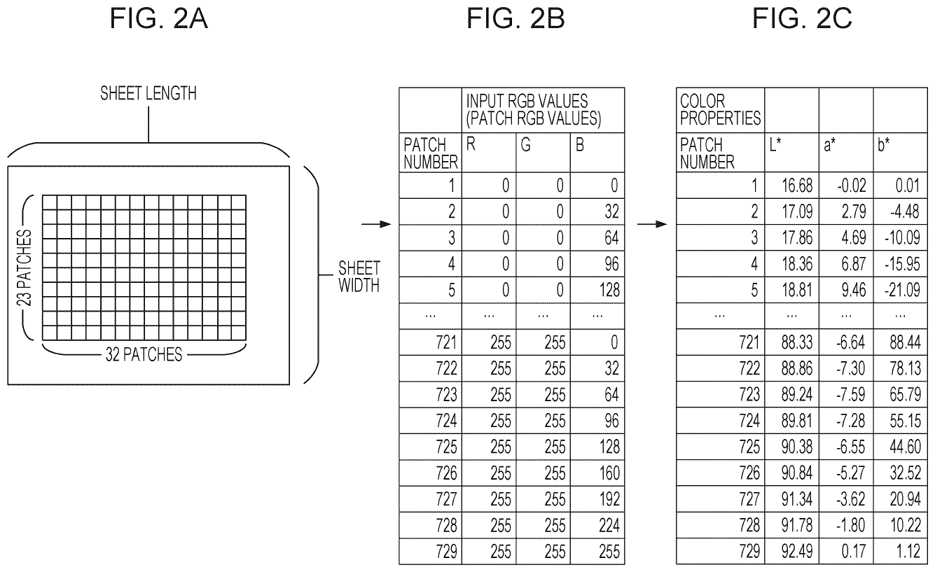

The measurement devices A to C (150a to 150c) are spectrophotometers that measure color values of targets on the basis of the reflectance or transmittance of visible light with wavelengths ranging from approximately 400 nm to 700 nm. The measurement devices A to C (150a to 150c) are prepared, for example, on a print location basis and obtain color measurement data by converting the wavelengths obtained for each patch of the charts printed out from the printers A to C (130a to 130c) into, for example, values in the L*a*b* color space or XYZ color space. FIG. 2A illustrates an example of a chart, and FIG. 2B illustrates target color values (RGB values) specified in the RGB color space corresponding to each patch (patch numbers 1 to 729) of the chart. The measurement devices A to C (150a to 150c) are measurement devices with built-in line or area sensors for scanning charts. For example, if the measurement devices are sheet-through type automatic document reading measurement devices, it is possible to pre-scan the chart using the built-in line sensors, and then measure each patch after detecting the position of the patch to be measured. If the measurement devices are capable of automatic paper feeding and continuous measurement, it is possible to pre-scan the chart using the built-in area sensors, and then measure each patch after detecting, in a similar way, the position of the patch to be measured. A portable (handheld) measurement device can also be used, but in that case, the color verification system is configured such that a scanner for scanning charts is separately connected to the control device 110. In the case of a sheet-through type automatic document reading measurement device, the sheet-through type automatic document reading measurement device is connected to the control device 110 via USB, for example, and measures the color value of each patch on the chart printed out from the target printer to obtain the color measurement data as illustrated in FIG. 2C. The acquired color measurement data is transmitted to the color verification device 100 via the control device 110. In a case where the color verification device 100 is installed at one of the locations A to C, the color verification device 100 may be directly connected to the measurement devices at the location where the color verification device 100 is installed, and the color verification device 100 may be configured to be able to acquire color measurement data without using the control device 110.

The network 160 is, for example, a local-area network (LAN), the Internet, an intranet, or the like, and may be a wired or wireless network. The locations A to C (170a to 170c) correspond to, for example, the locations of a printing company where the printers are installed. For example, the location A 170a is a printing location in Tokyo, the location B 170b is a printing location in Osaka, and the location C 170c is a printing location in Fukuoka.

Note that the configuration of the color verification system illustrated in FIG. 1 is an example, and the number of locations and the configuration of devices in each location can be changed as needed. For example, the color verification system may be configured such that the color verification device 100 is directly connected to the control device 110 and the measurement devices A to C via a communication network such as an intranet and manages the color accuracy of the multiple printers A to C. In addition, for example, an information processing device equipped with the functions of both the color verification device 100 and the control device 110 may be installed at each location, and the information processing device may be configured to manage the color accuracy of multiple printers in the location.

### Hardware Configuration of Information Processing Device (Color Verification Device/Control Device)

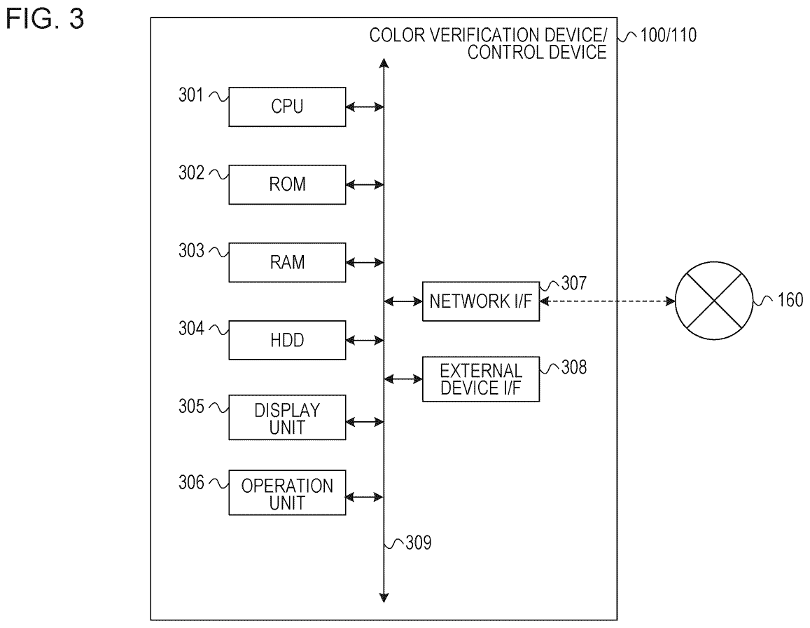

Next, with reference to FIG. 3, the hardware configuration of the information processing device according to the present embodiment will be described. FIG. 3 is a diagram illustrating an example of the hardware configuration of the information processing device according to the present embodiment. The information processing device according to the present embodiment corresponds to at least one of the color verification device 100 or control device 110 mentioned above, and is realized by, for example, a general-purpose notebook personal computer or desktop personal computer or a tablet terminal. Note that the color verification device 100 and the control device 110 may be installed so as to be integrated with each other. Thus, the color verification device 100 and the control device 110 are an example of the information processing device. Each of the color verification device 100 and the control device 110 has a central processing unit (CPU) 301, a read-only memory (ROM) 302, a random-access memory (RAM) 303, a hard disk drive (HDD) 304, a display unit 305, an operation unit 306, a network interface (I/F) 307, and an external device I/F 308. The CPU 301, the ROM 302, the RAM 303, the HDD 304, the display unit 305, the operation unit 306, the network I/F 307, and the external device I/F 308 are connected to each other via a system bus 309 such that two-way communication is possible.

The CPU 301 is an arithmetic processing device that controls the entire device and executes each process described below on the basis of the programs stored in the ROM 302. The ROM 302 is a read-only memory that stores boot programs, processing programs, character data, character code information, and the like. The RAM 303 is a random-access memory and is used as a work memory when the CPU 301 executes various programs. The RAM 303 is also used as a data storage area for, for example, image files received through the network I/F 307. The HDD 304 is used to store results of arithmetic processing performed by the CPU 301, various programs, and various information files, for example. The display unit 305 is constituted by, for example, a liquid crystal display and the like, and displays, for example, user interface screens (UI screens) for setting various settings and confirming the device status. The operation unit 306 is constituted by, for example, a keyboard and buttons, and is used by the user to input and reset various setting values, for example. The network I/F 307 is an interface for connecting the device to the network 160. Through this network I/F 307, the color verification device 100 and the control device 110 can each transmit and receive various types of information to and from external devices on the network 160. The external device I/F 308 is an interface for connecting the device to external devices, such as the measurement devices A to C, via a communication bus, such as Universal Serial Bus (USB), for example.

### Software Configuration of Information Processing Device (Color Verification Device/Control Device)

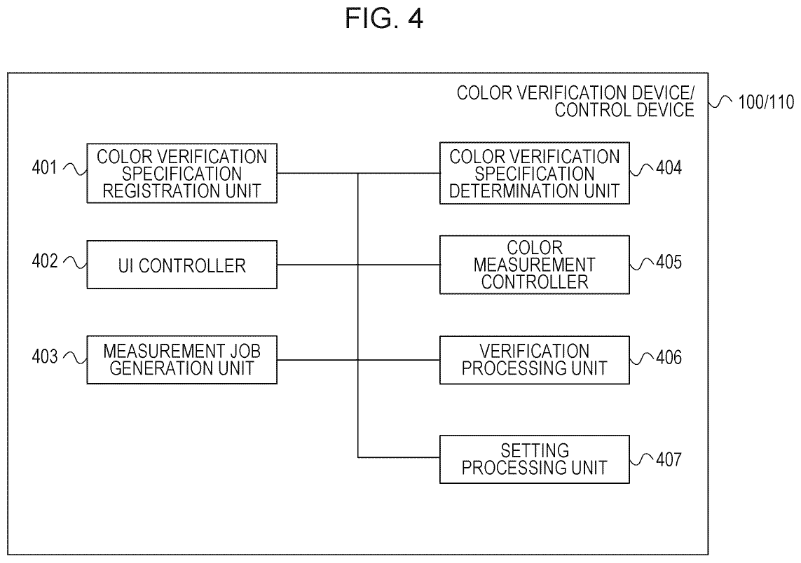

Next, the software configuration of the information processing device (the color verification device 100 and/or the control device 110) according to the present embodiment will be described with reference to FIG. 4. FIG. 4 is a diagram illustrating an example of the software configuration of the information processing device according to the present embodiment. In the following, several functional configurations of the information processing device will be described. However, other configurations are not excluded.

The color verification device 100 and the control device 110 each has a color verification specification registration unit 401, a UI controller 402, a measurement job generation unit 403, a color verification specification determination unit 404, a color measurement controller 405, a verification processing unit 406, and a setting processing unit 407. Each of these functional units 401 to 407 is realized by the CPU 301 executing predetermined programs. Each functional unit will be described below.

The color verification specification registration unit 401 accepts, for each color verification, registration (input) of, for example, a chart in which patches of various colors corresponding to target color values are arranged, a printer that is to be the target of color verification, a measurement device and color measurement conditions used for color verification, and tolerance values used in color verification. The color verification specification registration unit 401 is an example of an acceptance unit. Regarding a chart to be registered, image data and information (chart configuration information) indicating the configuration of the chart, such as the number of patches and the sizes of patches in the chart, are associated with each other, and the chart is stored in the HDD 304. Charts can be broadly classified into prescribed charts following International Standard Organization (ISO) and other standards, and custom charts customized by the user. Prescribed charts are registered in advance before the use thereof such as when the color verification program is installed. Custom charts are registered at any time based on the user's input made through the operation unit 306. The printer that is to be the target of color verification is registered from among the printers 130a, 130b, and 130c that are connected to the control device 110. The measurement device used for color verification is registered from among the measurement devices 150a, 150b, and 150c. Color measurement conditions defined by Japan Color certification and the like, compliant with ISO, are registered as the color measurement conditions used for color verification. Tolerance values based on Japan Color certification and the like, compliant with ISO, are registered as the tolerance values that are used for color verification. A tolerance value is used to check that the color accuracy meets an acceptance criterion by comparing a defined target color (target color) with the color actually printed by the printer (printed color). For example, in a case where a determination is made on the basis of the difference (color difference) between the color value (target value) of the target color and the color value (measured value) of the printed color, it is determined that the color accuracy meets the acceptance criterion when a color difference value is registered as the tolerance value and the difference is within the tolerance value. When performing color verification, for example, the user selects a color verification specification from among the registered color verification specifications, and the measurement job generation unit 403 generates a measurement job corresponding to the selected color verification specification to start color verification.

The UI controller 402 controls display of a user interface screen (UI screen) for the user to confirm the status of each device in the color verification system, input and select various setting values, and issue start commands for various processes, for example. The UI screens to be displayed will be described below. The measurement job generation unit 403 generates, as a measurement job, a job in which color verification is performed using one or more color verification specifications (color verification tests) selected by the user from among the registered color verification specifications. Thereafter, a chart is generated based on the chart configuration information corresponding to the selected color verification specification(s).

The color verification specification determination unit 404 performs preliminary verification to determine whether or not color verification specifications to be registered through the color verification specification registration unit 401 are valid. The color verification specification determination unit 404 is an example of a determination unit.

The color verification specification determination unit 404 registers color verification specifications based on the results of the preliminary verification. In addition, the color verification specification determination unit 404 provides feedback for setting the tolerance values based on the preliminary verification results of the color verification specifications, as necessary. Examples of the feedback include displaying an alert (error notification) and restricting the value ranges for setting the tolerance values. Note that the value ranges refer to the ranges of values that can be input as the tolerance values. The color measurement controller 405 performs pre-scanning on a chart in a case where color measurement is performed and controls performing of color measurement on the chart. The verification processing unit 406 uses color measurement data received from the measurement device to perform a verification process to determine whether or not the color accuracy of the target printer meets the acceptance criteria. The setting processing unit 407 sets, for example, various parameters related to the verification process based on, for example, the user's selection made through a predetermined user interface screen.

### Overall System Process Flow

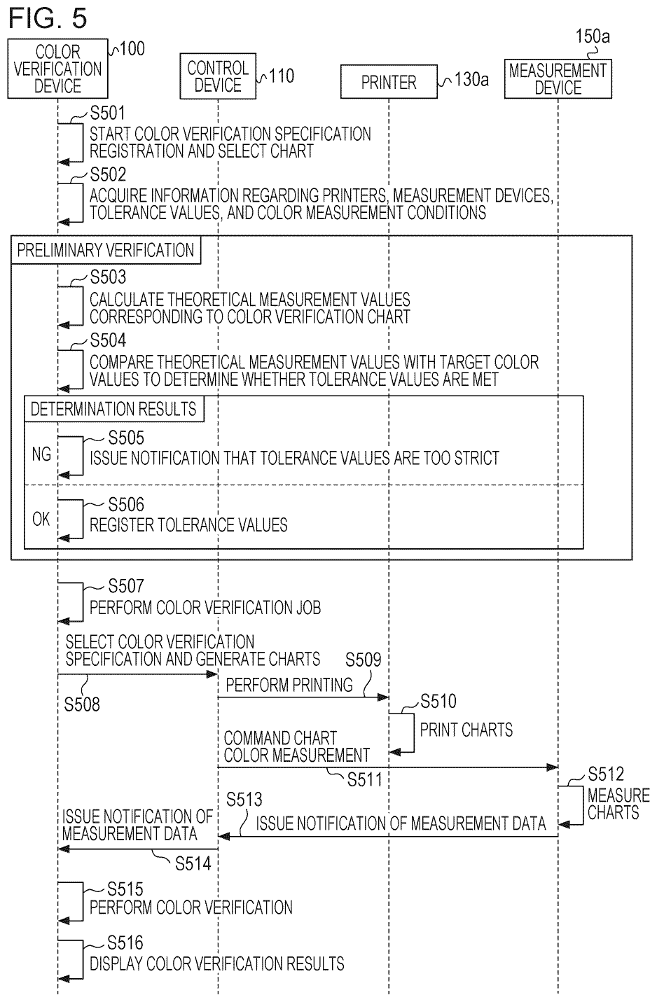

Next, the processing sequence of color verification in the color verification system according to the present embodiment will be described with reference to FIG. 5. FIG. 5 is a diagram illustrating an example of the processing sequence of color verification in the color verification system according to the present embodiment. In the processing sequence described below, it is assumed that multiple color verifications are performed, using the measurement device A 150a, by outputting multiple charts to the printer A 130a. Various operation screens described below are described as examples displayed on the display unit 305 of the color verification device 100 but are not limited thereto. The various operation screens may also be displayed on the display unit 305 of the control device 110 or other display units. Note that the symbol “S” refers to “Step” in the following description.

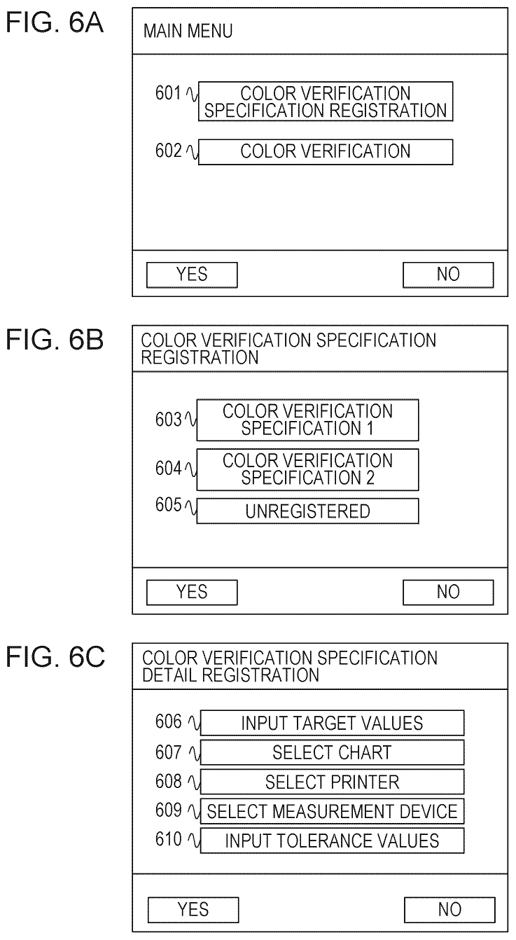

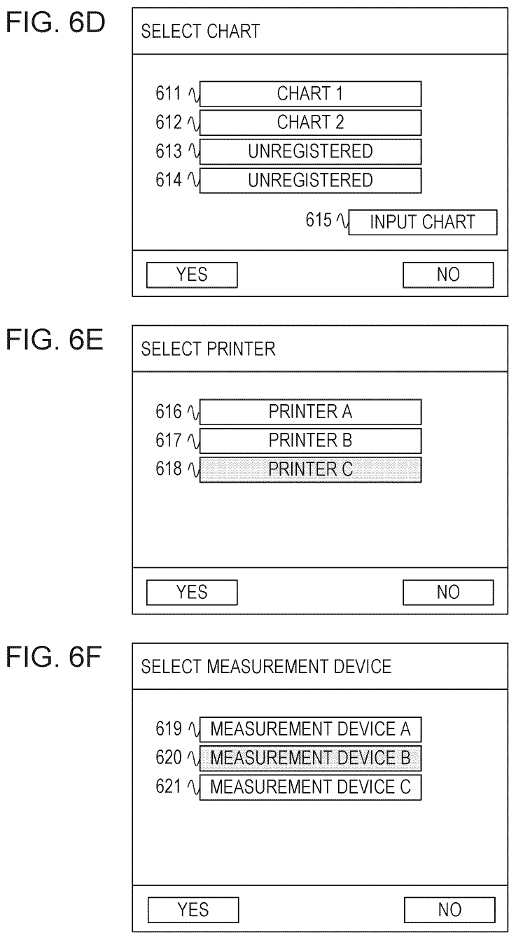

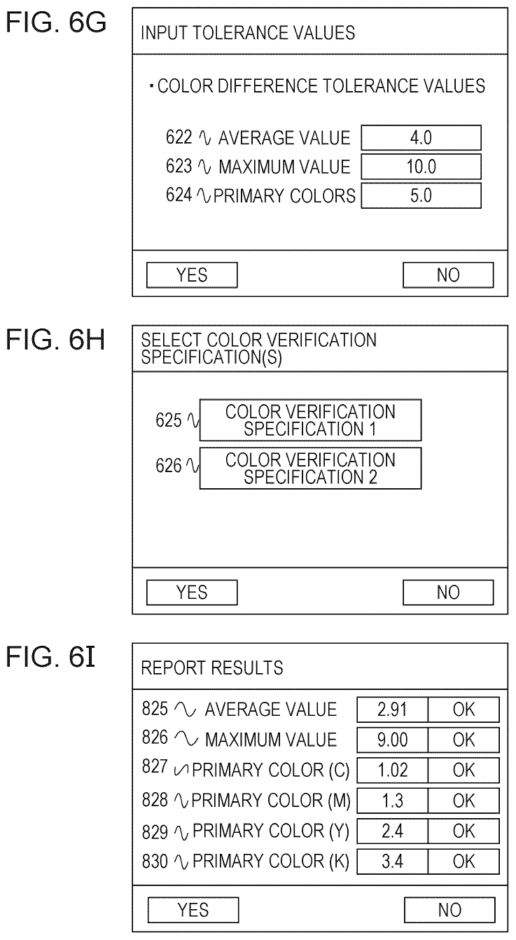

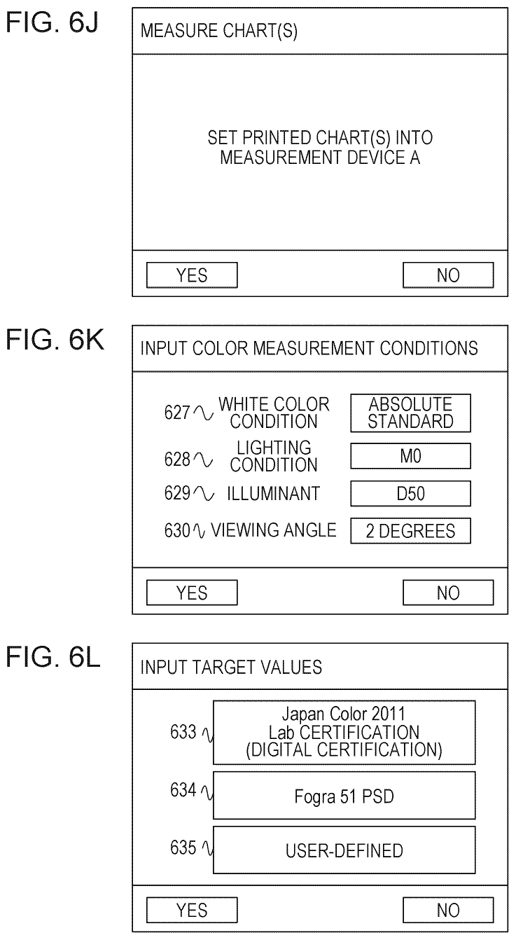

In S501, the color verification specification registration unit 401 starts color verification specification registration based on the user's input. When the user who wants to register color verification specifications presses a color verification specification registration button 601 on the main menu screen illustrated in FIG. 6A, the screen transitions to the color verification specification registration screen illustrated in FIG. 6B. The control of these UI screens, including the control of UI screens in the following description, is performed by the UI controller 402.

When the display region of the color verification specification to be registered or edited is pressed among display regions 603 to 605 of the color verification specification registration screen in FIG. 6B, the screen transitions to the color verification specification detail registration screen illustrated in FIG. 6C. In FIG. 6B, the display regions 603 and 604 indicate the color verification specifications that have already been registered, and the display region 605 indicates “Unregistered.” When one of the color verification specifications that have already been registered is selected, the content can be edited, and when “Unregistered” is selected, a new color verification specification can be registered. The color verification specification detail registration screen in FIG. 6C includes display regions 606 to 610, and the display regions 606 to 610 can each allow settings related to the corresponding color verification specification to be set.

Next, when “Select Chart” of the display region 607 is pressed on the color verification specification detail registration screen in FIG. 6C, the screen transitions to the chart selection screen illustrated in FIG. 6D. The user selects a chart to be used for color verification from among the display regions 611 to 614 of the chart selection screen illustrated in FIG. 6D. “Chart 1” and “Chart 2” of the display regions 611 and 612 on the chart selection screen in FIG. 6D are prescribed charts that are defined by ISO and other standards and that have already been registered. When the user presses chart input button 615, the user can input, for example, various types of information necessary to register a custom chart. Specifically, the registration of a custom chart is completed by inputting the name of the custom chart to be registered, the number of patches, patch size, and the paper size/type, and by uploading image data. Chart images are created in file formats such as TIFF, PDF, and JPEG, for example. This allows charts to be registered for “Unregistered” of the display regions 613 and 614 of the chart selection screen in FIG. 6D. Note that the list of registered charts and the chart configuration information for each chart are also collectively referred to as “chart information.”

In S502, the color verification specification registration unit 401 acquires the list of printers A to C managed by the control device 110 and information indicating the status of each printer (hereinafter also referred to as “printer status information”). In this case, the printer status information includes, for example, information such as power status (ON/OFF), presence or absence of a failure, and print job processing status (printing/waiting). This printer status information is acquired and retained by the control device 110 periodically accessing the printers A to C. Note that the list of printers and the printer status information for each printer are also collectively referred to as “printer information.”

Next, the color verification specification registration unit 401 accepts the user's pressing of “Select Printer” of the display region 608 on the color verification specification detail registration screen in FIG. 6C. Thereafter, the screen transitions to the printer selection screen illustrated in FIG. 6E, and a process for accepting the selection of a printer to be a color verification target (hereinafter also referred to as “target printer”) is performed. Specifically, the UI controller 402 accepts the user's selection through the UI screen displayed on the display unit 305, and the setting processing unit 407 sets the printer corresponding to the selection (the printer A in this case) as the target printer. FIG. 6E illustrates a printer selection screen displayed when the user selects a target printer. In display regions 616 to 618 of the printer selection screen, printers that may be processing targets (the printers A to C in this case) are listed and displayed in accordance with the printer information acquired in S502. In this case, based on the printer status information, a display process may be performed in which, for example, printers that are in a non-printable state are grayed out to clearly indicate whether the printers are in a printable or non-printable state. On the printer selection screen in FIG. 6E, only the printer C is grayed out, which indicates that the printer C is in the non-printable state.

Next, the color verification specification registration unit 401 acquires the list of measurement devices A to C managed by the control device 110, specification information regarding each measurement device, and information indicating the status of each measurement device (hereinafter also referred to as “measurement device status information”). In this case, the specification information is information indicating the specifications for each measurement device, such as supported paper sizes, the minimum patch size, and the minimum or maximum number of patches per sheet (per page). For measurement devices that are supplied with accessories, differences in specifications based on the presence or absence of accessories are also included in the specification information. In this case, the accessories refer to, for example, measurement rulers and automatic paper feeding units. A measurement ruler is a device that assists the sliding motion during measurement and enables stable color measurement in a handy-type measurement device.

A sensor installed on the back of the measurement device is configured to be able to detect the direction in which the user performs measurement (from left to right or from right to left, for example) by detecting the stripe pattern of the measurement ruler. An automatic paper feeding unit is a device that automatically takes the chart printed out from the printer into the measurement device to enable continuous color measurement. The measurement device status information includes, for example, information such as power status (ON/OFF) and connection status. The specification information and measurement device status information are acquired and retained by the control device 110 accessing the measurement devices A to C beforehand or periodically. Note that the list of measurement devices, the specification information for each measurement device, and the measurement device status information are also collectively referred to as “measurement device information.”

Next, the color verification specification registration unit 401 accepts the user's pressing of “Select Measurement Device” of the display region 609 on the color verification specification detail registration screen in FIG. 6C. Thereafter, the screen transitions to the measurement device selection screen illustrated in FIG. 6F, and a process for accepting selection of a measurement device to be used to measure the color values of the chart is performed. Specifically, the UI controller 402 accepts the user's selection through the UI screen displayed on the display unit 305, and the setting processing unit 407 sets the measurement device corresponding to the selection (the measurement device A in this case) as the measurement device to be used for chart measurement. FIG. 6F illustrates a measurement device selection screen displayed when the user selects a measurement device. In display regions 619 to 621 of the measurement device selection screen, measurement devices that may be processing targets (the measurement devices A to C in this case) are listed and displayed in accordance with the measurement device information acquired in S502. In this case, based on the measurement device status information, a display process may be performed in which, for example, measurement devices that are in the unusable state are grayed out to clearly indicate whether the measurement devices are in the usable or unusable state. On the measurement device selection screen in FIG. 6F, only the measurement device B is grayed out, which indicates that the measurement device B is in the unusable state.

Next, the screen transitions to the color measurement condition input screen illustrated in FIG. 6K, and a process for accepting color measurement conditions for color measurement is performed. Specifically, the UI controller 402 accepts the user's selection through the UI screen displayed on the display unit 305, and the setting processing unit 407 sets the color measurement conditions corresponding to the selection. FIG. 6K illustrates a color measurement condition input screen displayed when the user inputs various color measurement conditions. The color measurement conditions include, but are not limited to, a white color condition 627, a lighting condition 628, an illuminant 629, and a viewing angle 630. The white color condition 627 corresponds to the “paper white standard,” which is based on the white background of the actual printing paper, or the “absolute white standard,” which is based on the white reference plate (white tile) of the color measurement device, and either one is selected. The lighting condition 628 corresponds to “M0,” “M1,” “M2,” or “M3” standardized in ISO 13655, and one of them is selected. For the illuminant (observation light source) 629, the type of light source data that is incorporated when calculating L*a*b* values is selected. Examples of the type of light source data include “A,” “D50,” and “D65.” The viewing angle 630 relates to a person's viewing angle (the size of an object), and is selected from among, for example, “2-degree field of view” or “10-degree field of view,” defined by ISO standards.

In addition, when color verification is performed in accordance with Japan Color certification or Fogra certification compliant with ISO international standards, color measurement conditions are predetermined in accordance with the type of color certification. Thus, it is sufficient to use a configuration in which the user registers only the type of color certification and the color measurement conditions corresponding to the type of color certification registered are automatically registered within the color verification specification registration unit 401. In such a case, for example, it is sufficient that the color measurement conditions corresponding to the color certifications as illustrated in Table 1 be stored in advance as a table, and the color measurement conditions corresponding to the type of color certification be registered by referring to the table. The color verification system may also be configured to be able to register and delete the color measurement conditions customized by the user or administrator who performs color verification. For example, the administrator adds a color certification with “Custom: Profile A” described in Table 1 to the table in advance. The color verification system may be configured to be able to automatically register color measurement conditions within the color verification specification registration unit 401 when the user, who performs color verification, selects “Custom: Profile A” thereafter. Note that in the present example the color verification system is configured to register the color measurement conditions after the measurement device is selected in the present embodiment because usable color measurement conditions may differ depending on the measurement device selected. However, a “Select Color Measurement Conditions” display region may be provided on the menu screen in FIG. 6C, and a measurement device and color measurement conditions may be registered separately.

TABLE 1

| | Japan Color 2011 Lab | | ISO 12647-7 | |
|---|---|---|---|---|
| Color | Certification (Digital | Forga 51 | Proof | Custom: |
| verification | Printing Certification) | PSD | Printing | Profile A |
| Status | — | Status T | — | — |
| White Color | Absolute White Standard | Absolute | Absolute | Paper White |
| Condition | | White | White | Standard |
| | | Standard | Standard | |
| Lighting | M0 | M0 | M1 | M0 |
| Condition | | | | |
| Illuminant | D50 | — | D50 | D50 |
| (Observation | | | | |
| Light Source) | | | | |
| Viewing Angle | 2 Degrees | — | 2 Degrees | 2 Degrees |
| Geometric | 0/45 or 45/0 | 0/45 or 45/0 | 0/45 or 45/0 | Integrating |
| Condition | | | | Sphere |

Next, the color verification specification registration unit 401 accepts the user's pressing of “Input Tolerance Values” of the display region 610 on the color verification specification detail registration screen in FIG. 6C. Thereafter, the screen transitions to the tolerance value input screen illustrated in FIG. 6G, and a process for accepting data such as tolerance values for verification items for each patch is performed. Specifically, the UI controller 402 accepts the user's input through the UI screen displayed on the display unit 305, and the setting processing unit 407 sets the tolerance values for the verification items corresponding to the input. FIG. 6G illustrates the tolerance value input screen displayed when the user inputs tolerance values for the verification items. For example, an average value 622 of color differences ΔE for each patch, a maximum value 623 of the color differences ΔE, and a color difference ΔE 624 for the primary colors (CMYK) are used as the verification items, and tolerance values are set for the respective verification items. In this case, in CMYK, C is cyan, M is magenta, Y is yellow, and K is black. The user sets, in advance, tolerance values corresponding to the verification items through such a UI screen. In this case, the color difference ΔE is the linear distance between the target color value in the L*a*b* color space and the color value (color measurement value) indicated by the color measurement data and can be obtained, for example, by the following equation (1).

$$Δ E = \sqrt{Δ {L}^{2} + Δ {a}^{2} + Δ {b}^{2}} \\ Δ L = {L}_{1} - {L}_{2} \\ Δ a = {a}_{1} - {a}_{2} \\ Δ b = {b}_{1} - {b}_{2} \qquad ( 1 )$$

Assume that the color difference tolerance values for the respective verification items are set as illustrated on the tolerance value input screen in FIG. 6G. In this case, the color verification is successful (OK) if the average value of the color differences ΔE for each patch is within ±4.0, the maximum value of the color differences ΔE is within ±10.0, and the color difference ΔE (ΔE_primary color) for the primary colors (CMYK) is within ±5.0. In contrast, the color verification is unsuccessful (NG) if any of the verification items exceeds its tolerance value.

Similar to the above-mentioned color measurement conditions, when color verification is performed in accordance with Japan Color certification or Fogra certification compliant with ISO international standards, the tolerance values are predetermined in accordance with the type of color certification. Thus, it is sufficient to use a configuration in which the user registers only the type of color certification, and the tolerance values corresponding to the type of color certification are automatically registered within the color verification specification registration unit 401. In such a case, for example, it is sufficient that the tolerance values corresponding to the color certifications as illustrated in Table 2 be stored in advance as a table, and the tolerance values corresponding to the type of color certification be registered by referring to the table.

TABLE 2

| Color | Japan Color 2011 Lab Certification | Forga 51 | ISO 12647-7 Proof |
|---|---|---|---|
| verification | (Digital Certification) | PSD | Printing |
| Average ΔE00 | Less than or equal to 2 | Less than | Less than or equal |
| | | 2.5 | to 2.5 |
| Maximum | Less than or equal to 6 | — | Less than or equal |
| ΔE00 | | | to 5.0 |
| Spot ΔE00 | — | Less than | Less than or equal |
| | | 2.5 | to 3.0 |
| 95% ΔE00 | Less than or equal to 4 | Less than | Less than or equal |
| | | 4.5 | to 5.0 |

Next, the color verification specification registration unit 401 accepts the user's pressing of “Input Target Values” of the display region 606 on the color verification specification detail registration screen in FIG. 6C. Thereafter, the screen transitions to the target value input screen illustrated in FIG. 6L, and a process for accepting target values for each patch is performed.

Specifically, the UI controller 402 accepts the user's selection through the UI screen displayed on the display unit 305, and the setting processing unit 407 sets the target color values corresponding to the selection. FIG. 6L illustrates a target value input screen displayed when the user inputs target values. In the present embodiment, the examples of color verifications based on Japan Color certification (633) and Fogra certification (634) compliant with ISO international standards are described, and thus, target values are defined in accordance with the types of color certification.

Thus, the user registers only the type of color certification, and the target values corresponding to the type of color certification are automatically registered within the color verification specification registration unit 401. In such a case, the target values corresponding to the color certifications are stored in advance in the HDD 304, and the target values corresponding to the type of color certification are registered by referring to the stored data.

In S503, the color verification specification determination unit 404 calculates theoretical measurement values corresponding to the color verification chart (or acquires predetermined thresholds). The details of the process flow for calculating the theoretical measurement values corresponding to the color verification chart will be described below.

In S504, the color verification specification determination unit 404 compares the theoretical measurement values calculated in S503 with the target color values acquired in S502 to determine whether the ranges of the tolerance values acquired in S502 are met. In a case where the color verification specification determination unit 404 has determined that the ranges of the tolerance values are met (OK), the process in S506 is performed. In contrast, in a case where the color verification specification determination unit 404 determines that any of the ranges of the tolerance values is not met (NG), the process in S505 is performed. This allows the user to confirm whether or not the tolerance values acquired in S502 are valid numeric values. The specific process flow is described below.

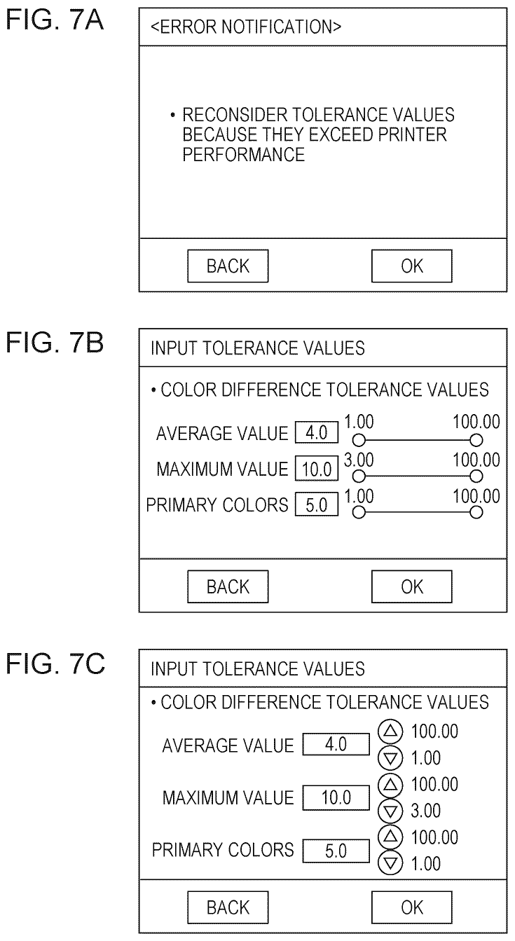

In S505, in a case where it is determined in S504 that any of the ranges of the tolerance values is not met, the color verification specification determination unit 404 causes the UI controller 402 to display, for example, an error notification screen as illustrated in FIG. 7A on the display unit 305, and issues a notification that the tolerance value(s) for the color verification specification is (are) too strict. Alternatively, the screen may be configured to restrict the value ranges for acquiring tolerance values such that numeric values between minimum values and maximum values (the maximum values can be any values) are selected using the sliders as illustrated in FIG. 7B. In such a case, the minimum values are set to the theoretical measurement values calculated in S503. Alternatively, the screen may be configured to restrict the value ranges for acquiring tolerance values by increasing and decreasing the numeric values in units of 1 using the steppers as illustrated in FIG. 7C. In such a case, the minimum values are set to the theoretical measurement values calculated in S503.

In S506, in a case where it is determined in S504 that the ranges of the tolerance values are met, the color verification specification determination unit 404 officially registers the color verification specification input in S501 and S502.

In S507, the measurement job generation unit 403 starts color verification based on the user's input. When the user who wants to start color verification presses a color verification button 602 on the main menu screen illustrated in FIG. 6A, the screen transitions to the color verification specification selection screen illustrated in FIG. 6H.

In S508, when either “Color Verification Specification 1” or “Color Verification Specification 2” of display regions 625 and 626 is pressed by the user on the color verification specification selection screen in FIG. 6H, the measurement job generation unit 403 generates a measurement job corresponding to the color verification specification and transmits the measurement job to the control device 110. Note that by selecting multiple color verification specifications at the same time, it is possible to generate multiple measurement jobs. When the measurement job is generated, the printer to be the color verification target, the measurement device and color measurement conditions to be used, the chart to be used for color verification, and the tolerance values are uniquely determined, which have been registered in the processes from S501 to S507.

In S509, the control device 110 transmits print jobs of multiple charts based on the received image data to the target printer. In this case, color conversion is performed on the received image data using input and output profiles. The input and output profiles are predetermined based on the color verification specification selected in S508. For example, in a case where color verification based on Japan Color 2011 Lab certification (digital certification) is performed, a profile created based on Japan Color 2011 is set as the input profile, and an output profile created by the target printer is set as the output profile. This allows color conversion for Japan Color 2011 Lab certification (digital certification) to be performed on the image data.

In S510, the printer A 130a, which has received the print jobs, performs print processing based on the print jobs and outputs charts.

In S511, the control device 110 displays the chart measurement screen illustrated in FIG. 6J and commands the color measurement of one or more charts printed out from the target printer.

In S512, when the user sets the one or more printed-out charts in the measurement device and commands the start of measurement, the selected measurement device (in this case, the measurement device A 150a) measures the color value of each patch on the chart(s).

In S513, after the selected measurement device completes the color value measurement for the one or more charts, the selected measurement device stores the obtained color measurement data and transmits the obtained color measurement data to the control device 110.

In S514, the control device 110 receives the color measurement data from the selected measurement device and transfers the color measurement data to the color verification device 100.

In S515, the verification processing unit 406 performs a color accuracy verification process on the target printer using the received color measurement data.

In S516, the UI controller 402 displays the verification results from the verification processing unit 406 on the display unit 305. FIG. 6I illustrates a report result screen that displays the verification results. As illustrated in FIG. 6I, a color difference average value 825, a maximum value 826, and color differences 827 to 830 for the primary colors (CMYK) are displayed together with the results of successful/unsuccessful (OK/NG) for the respective verification items. Such a report result screen enables the user to grasp the color variation status of the target printer. In a case where any of the verification results is unsuccessful (NG), the color variation of the printer can be suppressed within the specified limits by recreating the print profiles (output profiles) or performing a correction operation using the color correction function of the printer.

The above is the overall process flow in the color verification system according to the present embodiment. Together with the display prompting the user to measure the colors of the chart, the control device 110 may issue a preparation command to the selected measurement device to perform calibration before starting the measurement.

### Preliminary Verification Process (1)

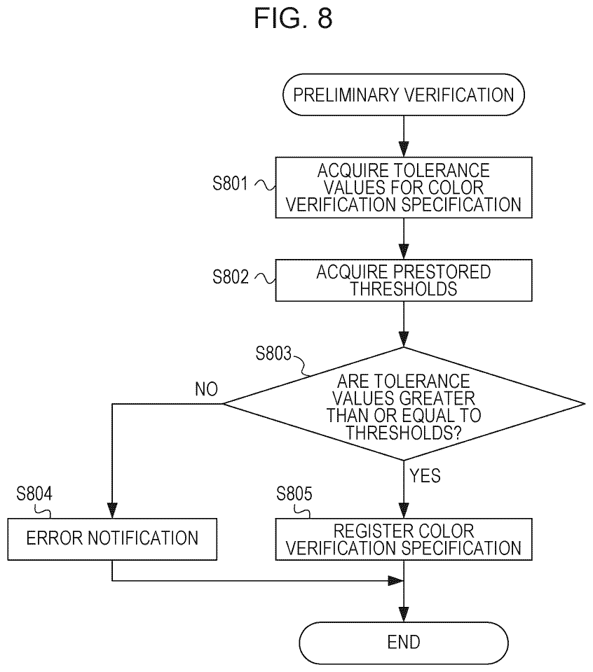

Next, an example of the processes in S503 and S504 of FIG. 5 will be described with reference to FIG. 8. The flowchart illustrated in FIG. 8 describes an example of determining whether or not the color verification specification (the tolerance values to be set) is valid by comparing predetermined thresholds with the tolerance values acquired in S502. The series of processes illustrated in the flowchart of FIG. 8 is realized by the CPU 301 of the color verification device 100 loading the program corresponding to the color verification specification determination unit 404 from the ROM 302 into the RAM 303 and executing the program. Note that the symbol “S” refers to “Step” in the following description.

In S801, the color verification specification determination unit 404 acquires the tolerance values for the color verification specification input in S502 of FIG. 5. In this case, the color verification specification determination unit 404 acquires the tolerance values for the respective verification items in the color verification specification.

In S802, the color verification specification determination unit 404 acquires predetermined thresholds stored in the HDD 304. In this case, the threshold values are, for example, values corresponding to the color conversion accuracy in the color conversion process in the target printer and are the lower limits of controllable color conversion accuracy.

In S803, the color verification specification determination unit 404 compares the tolerance values acquired in S801 with the thresholds acquired in S802 to determine whether or not the tolerance values are greater than or equal to the thresholds. That is, the color verification specification determination unit 404 determines whether or not the tolerance values acquired in S502 for the respective verification items as illustrated in the tolerance value input screen in FIG. 6G are within the acceptable ranges indicated by the thresholds acquired in S802. In a case where the color verification specification determination unit 404 has determined that the tolerance values for the verification items are greater than or equal to the thresholds (YES), the process in S805 is performed. In contrast, in a case where the color verification specification determination unit 404 has determined that the tolerance values for the verification items are not greater than or equal to the thresholds (NO), the process in S804 is performed.

In S804, which is performed in a case where the tolerance values for the verification items are not greater than or equal to the thresholds, the color verification specification determination unit 404 causes the display unit 305 to display an error notification screen or the like to notify the user of the error.

In S805, which is performed in a case where the tolerance values for the verification items are greater than or equal to the thresholds, the color verification specification determination unit 404 officially registers the color verification specification input in S501 and S502 of FIG. 5.

As a result, by comparing the predetermined thresholds with the tolerance values acquired in S502, it is verified whether the tolerance values to be set in the color verification specification are within the acceptable ranges and are therefore valid. By registering the color verification specification after it is determined that the tolerance values to be set are valid, the registration of color verification specifications in which inappropriate tolerance values are set and the occurrence of color verification NGs caused by setting inappropriate tolerance values can be prevented.

### Preliminary Verification Process (2)

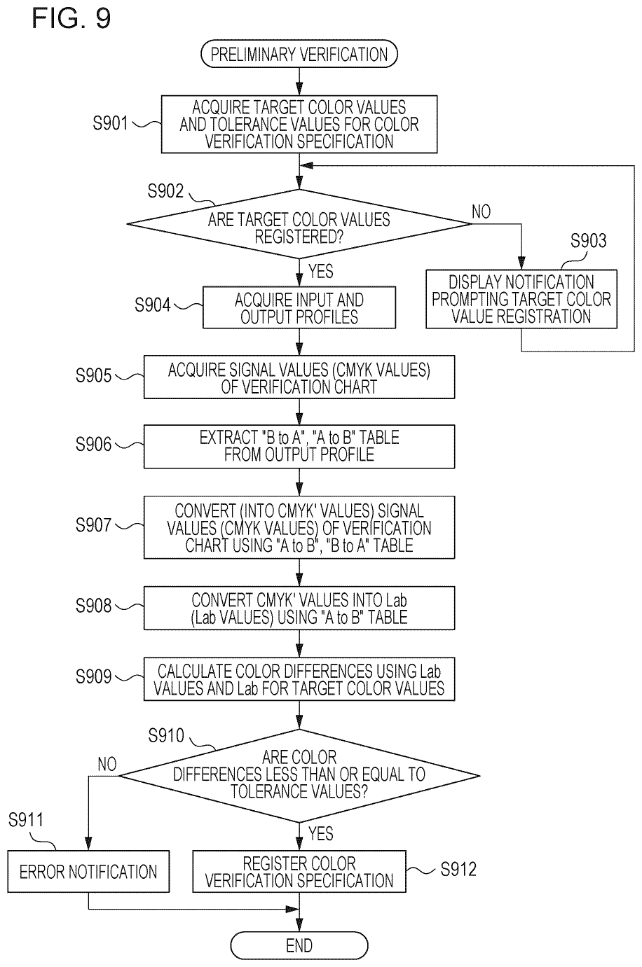

Next, with reference to FIGS. 9 to 11, another example of the processes in S503 and S504 of FIG. 5 will be described. In the flowchart illustrated in FIG. 9, an example will be described in which it is determined whether or not the color verification specification (the tolerance values to be set) is valid by calculating theoretical measurement values corresponding to the color verification chart selected in S501 of FIG. 5 and by comparing the theoretical measurement values with target color values. The series of processes illustrated in the flowchart of FIG. 9 is realized by the CPU 301 of the color verification device 100 loading the program corresponding to the color verification specification determination unit 404 from the ROM 302 into the RAM 303 and executing the program. Note that the symbol “S” refers to “Step” in the following description.

In S901, the color verification specification determination unit 404 acquires target color values and tolerance values for the color verification specification input in S502 of FIG. 5.

In S902, the color verification specification determination unit 404 determines whether or not the target color values are registered. In a case where the color verification specification determination unit 404 has determined that the target color values are registered (YES), the process in S904 is performed. In a case where the color verification specification determination unit 404 has determined that the target color values are not registered (NO), the process in S903 is performed.

In S903, which is performed in a case where it is determined that the target color values are not registered, the color verification specification determination unit 404 causes the display unit 305 to display an error notification screen (not illustrated) for notifying the user of the error and prompting the user to register target color values.

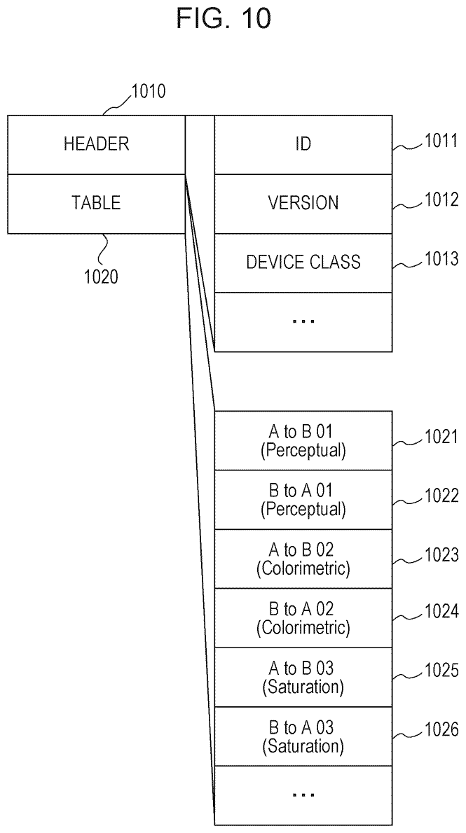

In S904, which is performed in a case where it is determined that the target color values are registered, the color verification specification determination unit 404 acquires the input and output profiles that are to be used when the chart is printed in the process in S509 of FIG. 5. The configuration of the profiles will be described. FIG. 10 is a diagram illustrating an example of an overview of such a profile. The profile has a header 1010 in which information regarding various profiles is described, and a table 1020 in which information used in color matching processing is described. The header 1010 contains, for example, ID information 1011, version information 1012, and device class information 1013 indicating the type of output device. The table 1020 stores pieces of “B to A” information 1022, 1024, and 1026, in which color processing parameters are described that are related to processing for converting image data B in a PCS space independent of output devices into image data A dependent on the color space of a certain device. In addition, the table 1020 stores pieces of “A to B” information 1021, 1023, and 1025, in which color processing parameters are described that are related to processing for converting image data A dependent on the color space of the certain device into image data B in the PCS space independent of output devices.

These pieces of “B to A” information and “A to B” information are stored so as to correspond to respective color matching methods supported by a color matching processing module. The types of color matching methods include color tone-priority color matching (Perceptual), colorimetric-prioritized color matching (Colorimetric), and vividness-priority color matching (Saturation), for example. In this case, “Perceptual” is color matching suitable for images such as photographs and focuses on color tones. “Colorimetric” is color matching suitable for images such as logos and aims to reproduce colors that are colorimetrically matched. “Saturation” is color matching suitable for images such as graphs and computer graphics (CGs) and focuses on color vividness.

To distinguish which color matching method each of these color processing parameters illustrated in FIG. 10 corresponds to, “Perceptual” is assigned the number “01,” “Colorimetric” is assigned the number “02,” and “Saturation” is assigned the number “03.”

In S905, the color verification specification determination unit 404 acquires signal values (for example, CMYK values) corresponding to the color verification chart selected in S501.

In S906, the color verification specification determination unit 404 extracts, using the output profile acquired in S904, the “A to B” information and “B to A” information corresponding to the color matching method used when the chart is printed.

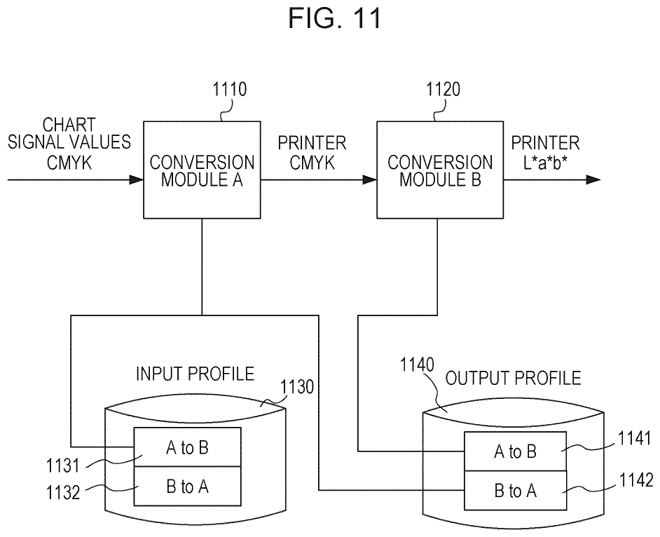

In S907, the color verification specification determination unit 404 performs a process for converting the signal values (CMYK values) corresponding to the color verification chart acquired in S905 into CMYK data (CMYK′ values) dependent on the characteristics of the printer, which is the output device. This process is performed by a conversion module A 1110 illustrated in FIG. 11. In this process, “A to B” information 1131 of an input profile 1130 and “B to A” information 1142 of an output profile 1140 corresponding to the specified color matching method are set in the conversion module A 1110. The conversion module A 1110 then performs color conversion using the set information, and the signal values (CMYK values) corresponding to the color verification chart are converted into CMYK data (CMYK′ values) dependent on the characteristics of the printer.

In S908, the color verification specification determination unit 404 converts the CMYK data (CMYK′ values) dependent on the characteristics of the printer converted in S907 into PCS data (for example, L*a*b* values) indicating the characteristics of the printer. This process is performed by a conversion module B 1120 illustrated in FIG. 11. In this process, “A to B” information 1141 of the output profile 1140 is set in the conversion module B 1120. Then, the conversion module B 1120 performs color conversion using the set information, and the CMYK data (CMYK′ values) dependent on the characteristics of the printer is converted into the PCS data (hereinafter also referred to as printer L*a*b*) indicating the characteristics of the printer.

In S909, the color verification specification determination unit 404 calculates color differences ΔE using the printer L*a*b* obtained as a result of the conversion in S908 and the L*a*b* for the target color values. The color differences ΔE can be calculated using the above-mentioned equation (1).

In S910, the color verification specification determination unit 404 compares the tolerance values acquired in S901 with the color differences ΔE acquired in S909 to determine whether or not the color differences ΔE are less than or equal to the tolerance values. That is, the color verification specification determination unit 404 determines, based on the color differences ΔE calculated in S909, whether or not the color difference tolerance values for the respective verification items as illustrated in the tolerance value input screen in FIG. 6G are met. In a case where the color verification specification determination unit 404 has determined that the tolerance values for the verification items are met (YES), the process in S912 is performed. In contrast, in a case where the color verification specification determination unit 404 has determined that the tolerance values for the verification items are not met (NO), the process in S911 is performed.

In S911, which is performed in a case where the tolerance values for the verification items are not met, the color verification specification determination unit 404 causes the display unit 305 to display an error notification screen or the like to notify the user of the error.

In S912, which is performed in a case where the tolerance values for the verification items are met, the color verification specification determination unit 404 officially registers the color verification specification input in S501 and S502 of FIG. 5.

As a result, theoretical measurement values corresponding to the color verification chart are acquired through simulation using the profiles, and it is possible to determine, by comparing the acquired theoretical measurement values with the target color values, whether or not the tolerance values are met. Thus, it is verified in advance whether the tolerance values to be set in the color verification specification are within the acceptable ranges and are therefore valid. By registering the color verification specification after it is determined that the tolerance values to be set are valid, the registration of color verification specifications in which inappropriate tolerance values are set and the occurrence of color verification NGs caused by setting inappropriate tolerance values can be prevented.

According to the present embodiment, in cases where color verification is performed using tolerance values customized by the user, when color verification specifications are registered, it is checked in advance whether or not the test contents (tolerance values) to be set are valid. For example, theoretical color values are acquired through simulation using profiles to simulate color conversion errors in software, and the validity of the tolerance values is determined based on whether or not the tolerance values are within the acceptable ranges that are based on the acquired theoretical color values (or predetermined thresholds). This allows tolerance values to be set that take into account the color conversion accuracy in software, thus preventing the registration of color verification specifications in which inappropriate tolerance values are set. It is therefore possible to prevent, in advance, unintentional color verification NGs in a case where tolerance values are not valid.

### Second Embodiment

In the first embodiment, as a method for checking in advance the validity of test contents (tolerance values) at the time of registration of a color verification specification, a mode is described in which the determination of whether the test contents (tolerance values) are valid at the time of registration of a color verification specification is based on whether or not tolerance values meet thresholds acquired through simulation using profiles (or predetermined thresholds). However, printer performance depends not only on color conversion errors in software, but also on engine density variation and in-plane irregularity in hardware. In a second embodiment, a mode is described in which thresholds are calculated through simulation using information regarding the density variation and in-plane irregularity in hardware, and the validity is determined based on whether or not the tolerance values meet the calculated thresholds.

Note that the description of the configuration of the color verification system, for example, which is common to that described in the first embodiment mentioned above, will be omitted. The overall configuration of the color verification system according to the present embodiment is substantially the same as that in the first embodiment mentioned above, and thus its description will be omitted. The hardware configurations of the color verification device 100 and the control device 110 according to the present embodiment are substantially the same as those in the first embodiment mentioned above, and thus their descriptions will be omitted.

The main functional configurations of the color verification device 100 and the control device 110 according to the present embodiment are substantially the same as those in the first embodiment mentioned above, and thus their descriptions will be omitted. The overall flow of processing in the color verification system according to the present embodiment is substantially the same as that in the first embodiment mentioned above, and thus its description will be omitted.

### Preliminary Verification Process (3)

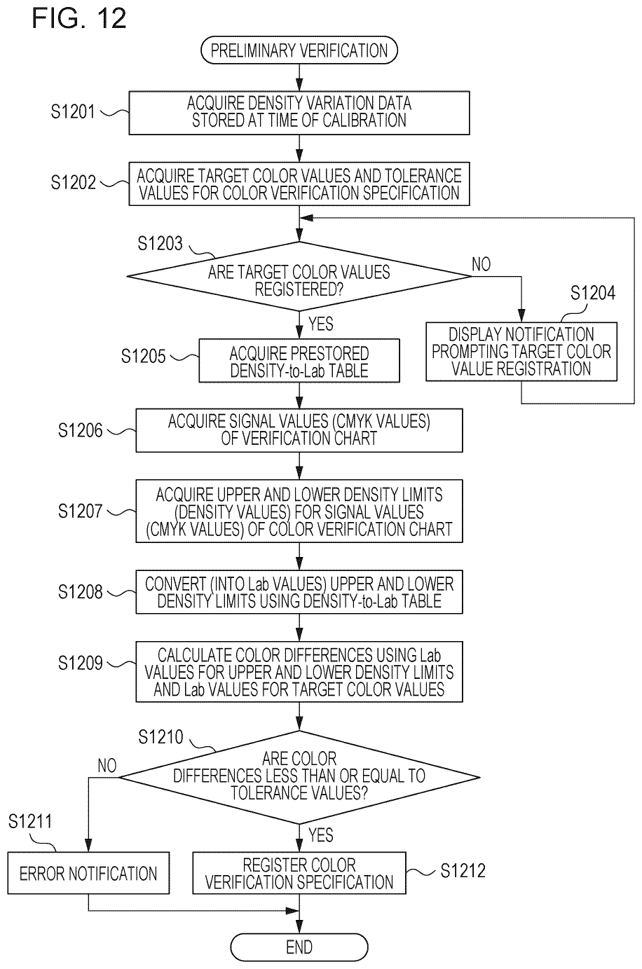

With reference to FIG. 12, an example of the processes in S503 and S504 of FIG. 5 in the second embodiment will be described. The flowchart illustrated in FIG. 12 describes an example of determining whether or not tolerance values in the color verification specification are valid by comparing the values obtained through simulation using information regarding density variations and in-plane irregularities with the tolerance values acquired in S502 of FIG. 5. The series of processes illustrated in the flowchart of FIG. 12 is realized by the CPU 301 of the color verification device 100 loading the program corresponding to the color verification specification determination unit 404 from the ROM 302 into the RAM 303 and executing the program. Note that the symbol “S” refers to “Step” in the following description.

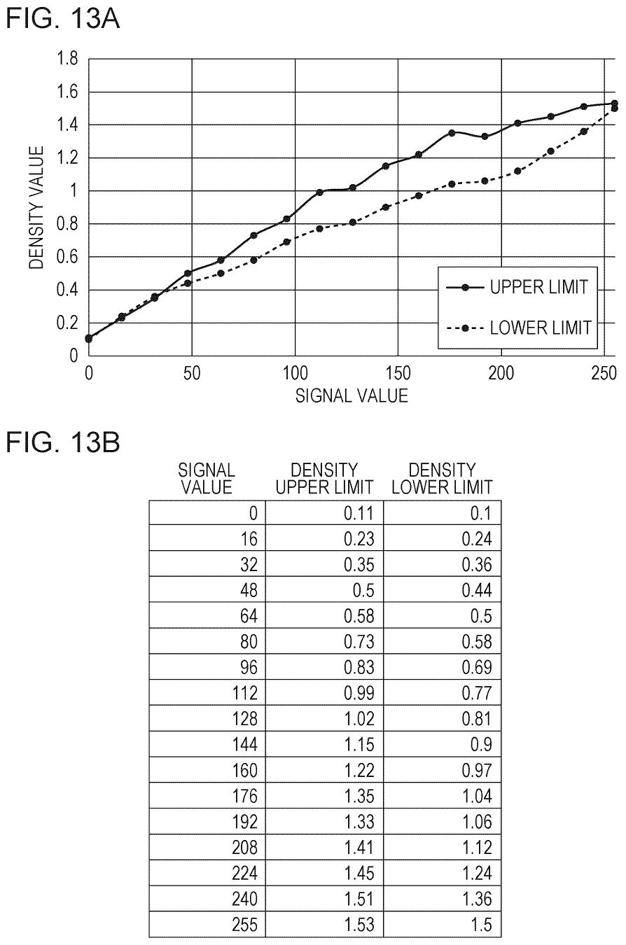

In S1201, the color verification specification determination unit 404 acquires density variation data stored at the time of calibration. In the following, calibration will be described. In electrophotographic image forming apparatuses, image density can fluctuate significantly due to the temperature and humidity at which the apparatuses are used, variations in the characteristics of the photosensitive member and developing agent, and the durability of the developer and other components. Color image forming apparatuses, in particular, also can experience problems with color tone changes. To address these problems, existing image forming apparatuses have built-in calibration technology that generates one-dimensional lookup tables (LUTs) for density correction corresponding to “single colors,” which are C, M, Y, and K. An LUT is a table that indicates output data corresponding to input data separated by specific intervals and can represent nonlinear characteristics that cannot be expressed by arithmetic equations. The one-dimensional LUTs for density correction represent the output signal values on the printer side that can represent the C, M, Y, and K input signal values, and the image is formed on paper using toner corresponding to these output signal values. First, a chart formed by data with different densities corresponding to C, M, Y, and K toners is prepared and output by a printer. For each of C, M, Y, and K, a one-dimensional LUT for density correction is generated independently by reading the chart output by the printer using scanners, color measurement devices, or other devices, and comparing the read values with the target data that is held in advance. This enables calibration to match the density characteristics of individual colors. In this case, for each of C, M, Y, and K, the upper limit value with the highest density and the lower limit value with the lowest density among the values read by scanners, color measurement devices, or other devices during past calibration are stored. For example, the graph illustrated in FIG. 13A represents density versus signal value, and the table in FIG. 13B summarizes the values of the graph in FIG. 13A. As illustrated in FIG. 13A, for example, the highest density value (upper density limit) and the lowest density value (lower density limit) are retained for each black (K) signal value from 0 to 255. In this process in S1201, for example, the color verification specification determination unit 404 acquires the retained upper and lower density limits as density variation data stored at the time of calibration.

Similarly, in-plane irregularities, where density fluctuates relative to the position in the main scanning direction (or sub-scanning direction) of the paper, may occur. To address this problem, the apparatuses also have calibration technology that generates one-dimensional LUTs for in-plane irregularity correction corresponding to “single colors,” which are C, M, Y, and K. In this regard, the upper and lower density limits among the values obtained by the scanners, color measurement devices, and other devices during past calibrations may be retained and acquired as density variation data.

In S1202, the color verification specification determination unit 404 acquires target color values and tolerance values for the color verification specification input in S502 of FIG. 5.

In S1203, the color verification specification determination unit 404 determines whether or not the target color values are registered. In a case where the color verification specification determination unit 404 has determined that the target color values are registered (YES), the process in S1205 is performed. In a case where the color verification specification determination unit 404 has determined that the target color values are not registered (NO), the process in S1204 is performed.

In S1204, which is performed in a case where it is determined that the target color values are not registered, the color verification specification determination unit 404 causes the display unit 305 to display an error notification screen (not illustrated) for notifying the user of the error and prompting the user to register target color values.

In S1205, the color verification specification determination unit 404 acquires a prestored density-to-Lab table. The density-to-Lab table is a four-dimensional LUT that outputs L*a*b* values for the density combinations corresponding to the C, M, Y, and K toners. The density-to-Lab table can be generated by causing a printer to output a chart formed by data with different densities corresponding to the C, M, Y, and K toners and measuring the densities and color values (L*a*b*) using color measurement devices or other devices. An interpolation operation using the density-to-Lab table can be used to calculate the L*a*b* values for any combination of C, M, Y, and K densities. For interpolation operations, it is sufficient that known general methods be applied.

In S1206, the color verification specification determination unit 404 acquires signal values (for example, CMYK values) corresponding to the color verification chart input in S501.

In S1207, based on the density variation data acquired in S1201, the color verification specification determination unit 404 acquires the upper and lower density limits for the signal values (CMYK values) corresponding to the color verification chart acquired in S1206. For example, according to the density data illustrated in FIG. 13B, in a case where the signal values corresponding to the color verification chart are CMYK=(0, 0, 0, 240), the upper density limits are CMYK=(0, 0, 0, 1.51), and the lower density limits are CMYK=(0, 0, 0, 1.36).

In S1208, the color verification specification determination unit 404 converts, using the density-to-Lab table acquired in S1205, the upper and lower density limits in the color verification chart acquired in S1207 into L*a*b* values.

In S1209, the color verification specification determination unit 404 calculates color differences ΔE1 using the L*a*b* values for the upper density limits and obtained as a result of the conversion in S1208 and the L*a*b* values for the target color values acquired in S1202. Moreover, the color verification specification determination unit 404 calculates color differences ΔE2 using the L*a*b* values for the lower density limits and obtained as a result of the conversion in S1208 and the L*a*b* values for the target color values acquired in S1202. The color differences ΔE (the color differences ΔE1 and color differences ΔE2) can be calculated using the above-mentioned equation (1).

In S1210, the color verification specification determination unit 404 compares the tolerance values acquired in S1202 with the color differences ΔE (the color differences ΔE1 and the color differences ΔE2) calculated in S1209 to determine whether or not the color differences ΔE are less than or equal to the tolerance values. That is, the color verification specification determination unit 404 determines, for both the color differences ΔE1 and the color differences ΔE2 calculated in S1209, whether or not the color differences meet the tolerance values for the respective verification items as illustrated on the tolerance value input screen in FIG. 6G. In a case where the color verification specification determination unit 404 has determined that the tolerance values for the verification items are met (YES), the process in S1212 is performed. In contrast, in a case where the color verification specification determination unit 404 has determined that the tolerance values for the verification items are not met (NO), the process in S1211 is performed.

In S1211, which is performed in a case where the tolerance values for the verification items are not met, the color verification specification determination unit 404 causes the display unit 305 to display an error notification screen or the like to notify the user of the error.

In S1212, which is performed in a case where the tolerance values for the verification items are met, the color verification specification determination unit 404 officially registers the color verification specification input in S501 and S502 of FIG. 5.

As a result, theoretical measurement values corresponding to the color verification chart are acquired through simulation using information regarding density variations, and it is possible to determine, by comparing the acquired theoretical measurement values with the target color values, whether or not the tolerance values are met. Thus, it is verified in advance whether the tolerance values to be set in the color verification specification are within the acceptable ranges and are therefore valid. By registering color verification specifications after it is determined that the tolerance values to be set are valid, the registration of color verification specifications in which inappropriate tolerance values are set and the occurrence of color verification NGs caused by setting inappropriate tolerance values can be prevented.

In the present embodiment, an example has been described in which simulation is performed using information regarding density variations; however, it is also possible to determine, using a similar configuration, whether or not the tolerance values are met through simulation using information regarding in-plane irregularities. The information is not limited to density variations and in-plane irregularities, and information such as other engine variations that affect color values (for example, thread irregularities and color shift) may also be used.

According to the present embodiment, in cases where color verification is performed using tolerance values customized by the user, when color verification specifications are registered, it is checked in advance whether or not the test contents (tolerance values) to be set are valid. For example, color values are calculated through simulation using information regarding density variations and in-plane irregularities in hardware, and the validity of the tolerance values is determined based on whether or not the tolerance values are within the acceptable ranges that are based on the calculated color values. This makes it possible to prevent the registration of color verification specifications in which values exceeding the calibration accuracy in the target printer are set as tolerance values. This allows tolerance values to be set that take into account the engine density variations and in-plane irregularities in hardware. Thus, it is possible to prevent the registration of color verification specifications in which inappropriate tolerance values are set and prevent unintentional color verification NGs in advance when tolerance values are not appropriate.

Note that in the first embodiment mentioned above and the second embodiment, examples have been described in which it is checked in advance whether or not the test contents (tolerance values) set at the time of registration of the color verification specification are valid. However, a configuration may also be used in which preliminary verification is periodically performed on test contents (tolerance values) for each registered color verification specification at user-set automatic scheduled timings and a notification is issued in a case where the test contents (tolerance values) for the color verification specification are not valid. In addition, a configuration may also be used in which preliminary verification is performed on the test contents (tolerance values) for each registered color verification specification at timings at which consumables such as toner are replaced or calibration is performed and a notification is issued in a case where the test contents (tolerance values) for the color verification specification are not valid. Moreover, a configuration may also be used in which preliminary verification is skipped and a color verification specification is registered in a case where the same color verification specification (measurement devices, charts, printers, etc.) used at the time of color verification is present and has already been preliminarily verified against the tolerance values.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims priority to and the benefit of Japanese Patent Application No. 2024-100706, filed Jun. 21, 2024, the entirety of which is incorporated herein by reference.

What is claimed is:

1. A non-transitory computer-readable storage medium storing a program for causing a computer of an information processing device to perform a control method, the information processing device being configured to verify color accuracy of an image forming apparatus using a color measurement result of a color patch arranged on a chart printed out from the image forming apparatus, the control method comprising the steps of:
accepting a color verification specification regarding color accuracy verification;
determining whether or not a tolerance value set in the accepted color verification specification is within an acceptable range; and
registering the color verification specification if the set tolerance value is determined to be within the acceptable range.

2. The storage medium according to claim 1, wherein the tolerance value set in the accepted color verification specification is determined to be within the acceptable range if it is greater than or equal to a predetermined threshold.

3. The storage medium according to claim 1, the control method further comprising the step of: acquiring, through simulation, a color value corresponding to a verification chart used in color accuracy verification, wherein
the tolerance value set in the accepted color verification specification is determined to be within the acceptable range if a color difference between the color value corresponding to the acquired verification chart and a target color value is less than or equal to the tolerance value set in the accepted color verification specification.

4. The storage medium according to claim 3, wherein the color value corresponding to the verification chart is acquired through simulation using a profile.

5. The storage medium according to claim 3, wherein the color value corresponding to the verification chart is acquired through simulation using an upper density limit and a lower density limit of at least one of density variation or in-plane irregularity in the image forming apparatus.

6. The storage medium according to claim 1, the control method further comprising the step of: issuing an error notification if the tolerance value set in the accepted color verification specification is determined to be not within the acceptable range.

7. The storage medium according to claim 1, the control method further comprising the step of: restricting, based on the accepted color verification specification and a predetermined acceptable range, a value range that is used when setting the tolerance value.

8. The storage medium according to claim 1, wherein the tolerance value set in the accepted color verification specification is determined to be within the acceptable range if it does not exceed a color conversion accuracy in the image forming apparatus.

9. The storage medium according to claim 1, wherein the tolerance value set in the accepted color verification specification is determined to be within the acceptable range if it does not exceed a calibration accuracy in the image forming apparatus.

10. The storage medium according to claim 1, wherein a determination as to whether or not the tolerance value set in the accepted color verification specification is within the acceptable range is made at a set timing.

11. The storage medium according to claim 1, wherein a determination as to whether or not the tolerance value set in the accepted color verification specification is within the acceptable range is made at a timing at which a consumable is replaced or calibration is performed.

12. An information processing device configured to perform color measurement on a color patch arranged on a chart printed out from an image forming apparatus to verify color accuracy of the image forming apparatus, comprising:
at least one memory storing a program; and
at least one processor that is configured to operate, by executing the stored program, as:
an acceptance unit configured to accept a color verification specification regarding color accuracy verification; and
a determination unit configured to determine whether or not a tolerance value set in the accepted color verification specification is within an acceptable range and register the color verification specification if the set tolerance value is determined to be within the acceptable range.

13. An information processing device control method for performing color measurement on a color patch arranged on a chart printed out from an image forming apparatus to verify color accuracy of the image forming apparatus, comprising the steps of:
accepting a color verification specification regarding color accuracy verification,
determining whether or not a tolerance value set in the accepted color verification specification is within an acceptable range, and
registering the color verification specification if the set tolerance value is determined to be within the acceptable range.
